(19) United States
(12) Patent Application Publication
(10) Pub. No.: US 2016/0158655 A1
(43) Pub. Date: Jun. 9, 2016

(54) MUSIC VIDEO GAME WITH PARALLEL FRET OPERATION

(71) Applicants: Neil Wigfield, Warwick (GB); Nathan Coppard, Leamington Spa (GB)

(72) Inventors: Neil Wigfield, Warwick (GB); Nathan Coppard, Leamington Spa (GB)

(21) Appl. No.: 14/839,583

(22) Filed: Aug. 28, 2015

Related U.S. Application Data
(60) Provisional application No. 62/087,597, filed on Dec. 4, 2014.

(51) Int. Cl. A63F 13/814

(52) U.S. Cl. CPC A63F 13/814

(57) ABSTRACT

A music-based video game may make use of a guitar-shaped controller including parallel rows of fret buttons. Instructive cues for play of the video game may use directional elements to differentiate between instructions to depress or play different ones of the fret buttons

### CROSS REFERENCE TO RELATED APPLICATIONS

This application claims the benefit of the filing date of U.S. Provisional Patent Application No. 62/087,597, filed on Dec. 4, 2014, the disclosure of which is incorporated by reference herein.

### BACKGROUND OF THE INVENTION

The present invention relates generally to music-based video games, and more particularly to music-based video games with a guitar-shaped controller.

Video games provide fun and enjoyment for many. Video games allow game players to participate in a variety of simulated activities. Video games allow game players to perform roles and experience activities that the game players may not be able or desire to experience directly, whether due to cost, danger, or equipment concerns, or simply due to a role or activity being a fantasy.

Video game systems have traditionally utilized a variety of input controllers to allow a game player to interact with the game, including, for example, joysticks, gamepads, keyboards, mice, trackballs, touch screens, or other known controllers. By operating such controllers, the video games allow game players to experience activities, at least to an extent, that the game players may otherwise be unable or incapable of taking part in.

In many instances, traditional input controllers are adapted for use with a wide variety of video games. The use of generic controllers is convenient, allowing a game player to use a single controller with a wide variety of video games and simulated activities. The use of generic input controllers may, however, detract from the experience of a simulated activity, considering that a generic controller may not in fact be utilized in the activities being simulated.

One genre of video games is the music-based video game, also referred to as rhythm-action games or rhythm games. Music-based video games often present instructive cues for manipulation of buttons and the like on an input controller, with the video game providing music and increasing a game player's score if the game player complies with the instructive cues. An additional element of realism may be provided by use of an input controller that at some level mimics look and feel of a musical instrument.

Video game play relies on both user operation of a controller and video displays, however. Providing more than the most minimal element of realism for the input controller may be difficult without so complicating the video displays, and indeed operation of the controller, that the video game is, for useful purposes, unplayable.

### BRIEF SUMMARY OF THE INVENTION

Aspects of the invention relate to a music-based game which makes use of a guitar-shaped controller with parallel opposing rows of fret buttons.

One aspect of the invention provides a non-transitory computer readable medium including program instructions to program a processor of a video game compute device, the program instructions including program instructions to: command display of notes on a display, the notes providing instructive cues to a game player, the notes scrolling in a first plurality of lanes, the notes including a first set of notes and a second set of notes, the first set of notes having a first shape and the second set of notes having a second shape different than the first shape, the notes providing instructive cues to a game player for operation of a second plurality of fret buttons of a guitar-shaped controller, a number of the second plurality of fret buttons being at least twice a number of the first plurality of lanes; determine if user inputs from a game controller indicate game player compliance with the instructive cues provided by the notes; and increase a score associated with the game player if the user inputs from the game controller indicate game player compliance with instructive cues provided by the notes.

Another aspect of the invention provides a video game system for a music-based video game, comprising: a video game compute device comprising a processor programmed by program instructions to provide for video game play of the music-based video game; and a guitar-shaped controller having a body with a neck extending longitudinally from the body, a strum bar providing a strum bar input protruding from a face of the body, and a plurality of fret buttons on the neck, the plurality of fret buttons including a first set of fret buttons and a second set of fret buttons, each fret button of the first set of fret buttons opposing a corresponding fret button of the second set of fret buttons across a plane including a line defined by a longitudinal middle of the neck; with the program instructions including program instructions to: command display on a display of notes moving in a plurality of lanes, the notes providing instructive cues to a game player as to operation of the plurality of fret buttons, the notes including a first set of notes having a first shape and a second set of notes having a second shape, the first set of notes providing instructive cues to the game player to operate the first set of fret buttons, the second set of notes providing instructive cues to the game player to operate the second set of fret buttons, with notes of the first set and notes of the second set each moving in each of the plurality of lanes, each lane of the plurality of lanes being associated with a different fret button of the first set of fret buttons and a different fret button of the second set of fret buttons, determine game player compliance with the instructive cues based on inputs from the fret buttons of the guitar-shaped controller and the strum bar input, and increase a score associated with the game player if the game player has complied with the instructive cues.

These and other aspects of the invention are more fully comprehended upon review of this disclosure.

### BRIEF DESCRIPTION OF THE FIGURES

FIG. 1 shows a video game system in accordance with aspects of the invention.

FIG. 2 shows a guitar-shaped controller in accordance with aspects of the invention.

FIG. 3 shows a screen-shot of a game display in accordance with aspects of the invention.

FIG. 4 shows various instructive cues in accordance with aspects of the invention.

FIG. 5 is a flow diagram of a game play process in accordance with aspects of the invention.

FIG. 6 is a flow diagram of a process for determining hammer-on, pull-off related displays during game play in accordance with aspects of the invention.

### DETAILED DESCRIPTION

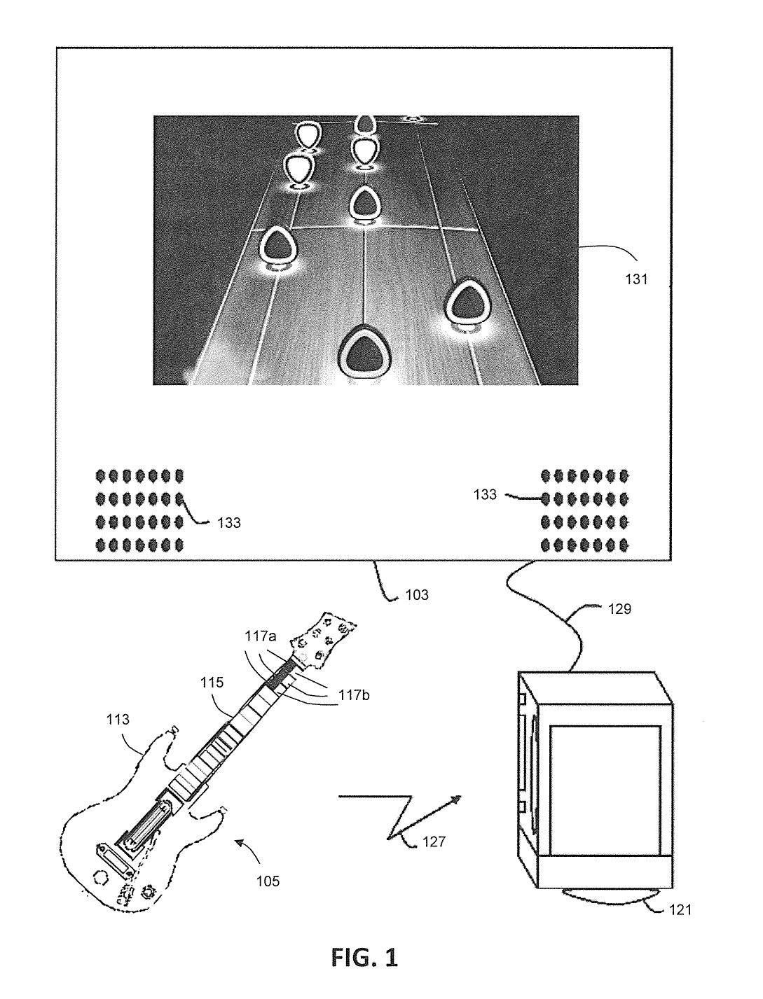

FIG. 1 shows a game system in accordance with aspects of the invention. The game system of FIG. 1 includes a video game compute device 121, a display 103, and a controller 105. The video game compute device includes internal circuitry that allows the compute device to run a video game by executing various program instructions related to proper execution of the video game. The video game compute device typically includes one or more processors, memory, and various interface circuitry, for example, interface circuitry for coupling to a network. In some embodiments the video game compute device is a video game console.

Instructions providing for operation during game play are generally stored on removable media, for example, an optical disk, although they may instead or in addition be stored on non-removable media in various embodiments. Accordingly, the game compute device may include an optical drive, for example, a DVD-ROM, CD-ROM, Blu-ray drive, or similar device, for reading the instructions for operating during game play. In other embodiments, the instructions providing for operation during game play may be stored in a remote server that is accessed over one or more networks. In yet other embodiments, the instructions providing for operation during game play may be stored on the local memory of the video game console.

The video game console of FIG. 1 is coupled to the controller by a wireless connection 127. In many embodiments, the controller and video game console may be coupled by a wired connection. In addition, the controller illustrated in FIG. 1 is in the shape of a guitar. In various embodiments, other controllers may instead or additionally be used, including generic controllers, microphones, drums, drumsticks, keyboards, DJ turntables, dance pads or mats, other guitar-shaped controllers, or controllers in the general form of other musical instruments.

In FIG. 1, the game controller 105 is in the form of a guitar-shaped controller. In some embodiments, the guitar-shaped controller includes a body 113 and neck 115. Controller 105 may further comprise various input buttons that permit the user to interact with the video game console, such as strum bar, whammy bar, neck input, and controller buttons. The neck 115 includes a plurality of fret buttons. As shown in FIG. 1, the plurality of fret buttons include a first plurality of fret buttons 117a and a second plurality of fret buttons 117b. In the embodiment of a guitar-shaped controller shown in FIG. 1, the first plurality of fret buttons and the second plurality of fret buttons are arranged linearly on opposing sides of a longitudinal midline going along a length of the neck from the body towards a head of the end of the neck. Considering that the guitar-shaped controller may often be used with the length of the neck somewhat parallel to the ground, each of the plurality of fret buttons may be considered to be a row of fret buttons, with the first plurality of fret buttons 117a being in an upper row and the second plurality of fret buttons 117b being in a lower row.

In some embodiments, controller 105 may also comprise one or more motion sensing devices, which determine the motion of the controller and/or user, and allow the user to interact with the video game console using physical movements. Motion sensing devices may include, for example, one or more gyroscopes, accelerometers, altimeters, geomagnetic sensors, magnetometers, optical or infrared projectors and transceivers, depth-sensing cameras, global positioning systems, thermal imaging systems, or any other similar device that generates signals provided to the video game console from which the video game console can determine motion of the controller and/or user. In some embodiments, the motion sensing device may be worn by the user. As used herein, the term “motion” is used broadly to encompass motion, position, posture, orientation, and location. Examples of systems incorporating exemplary motion sensing devices include the Nintendo Wii and Wii U, Sony PlayStation Move, and Microsoft Kinect platforms.

The video game console is in communication with a display unit 103, generally through an audio-video cable or similar wired connection, although a wireless connection may be used in some embodiments. Display unit 103 is generally some television or monitor. In many embodiments, the display unit 103 is a liquid crystal display (LCD), light-emitting diode (LED) display, or some other flat-panel display. In some embodiments, the display unit 203 is integrated with the video game console. The display unit generally comprises a display screen 131 and at least one audio output device, such as a speaker 133. In the embodiment of FIG. 1, the display screen shows a screen shot of video game play in a music-based video game.

In the particular screenshot of FIG. 1, the display includes a plurality of instructive cues. The instructive cues generally scroll across portions of the screen towards and into a predefined area of the screen, such as a note catcher or new line (not shown in FIG. 1). Although the screenshot of FIG. 1 shows the instructive cues scrolling in a substantially vertical direction, the instructive cues may scroll in any direction or along an arbitrary path. In many embodiments, the instructive cues may represent musical notes to be effectively played by the user, by way of operation of the game controller, and failure to comply with the instructive cue may be considered as equivalent to the user missing a note during video game play. The display, in some embodiments, may show a game scene, such as a music concert scene.

During video game play, a user is to depress or have depressed various buttons and/or utilize a strum bar or other user manipulable input device of the controller responsive to the instructive cues, generally when the instructive cues reach a predefined area of the display such as the note catcher (not shown in FIG. 1). The note catcher, for example, represents the time at which the user must respond to an instructive cue (e.g., a musical note). In some embodiments, the note catcher is designed so that the instructive cue fits into the note catcher at the right time.

In most embodiments, the video game console evaluates the user's performance based on the extent of the user's compliance with the operations commanded by the instructive cues. In addition, the video game console generally commands presentation of audio during video game play. In most embodiments, audio of a musical selection is provided if the user complies with the instructive cues, and silence, which in some embodiments, may be a lack of audio of part of the musical selection, or a sound associated with a missed note may be provided if the user does not comply with the instructive cues. Whether silence or a sound associated with a missed note is provided may depend, for example, on whether the user operates incorrect input commands or does not operate any input device. In various embodiments, the presentation of audio may also include audio from a crowd of the game world, with for example, the crowd being an audience for a musical performance.

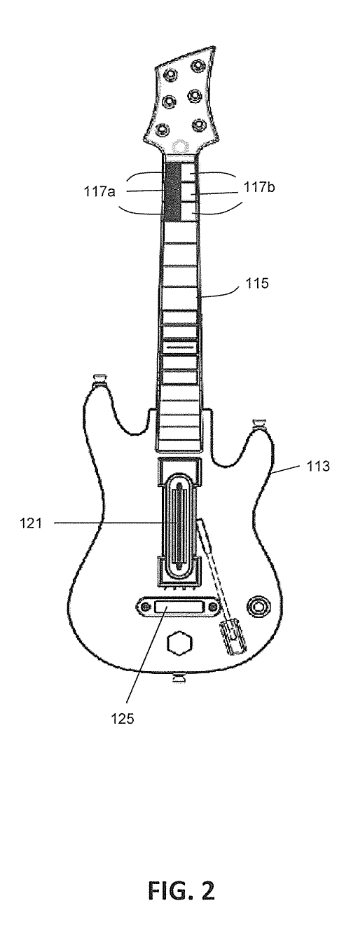

FIG. 2 provides an expanded view of the guitar-shaped controller of FIG. 1. As previously mentioned, the guitar-shaped controller includes a body 112, and a neck 115 extending from the body. A strum bar 121 protrudes from a face of the body. In operation a game player may actuate the strum bar, in a manner similar to strumming strings of a guitar. The guitar-shaped controller may also have other game player elements associated with the body, for example a button input 125.

The neck of the guitar-shaped controller includes fret buttons as game player input devices. For the guitar-shaped controller of FIG. 2, the fret buttons include fret buttons on either side of a longitudinal mid-line of the neck, with the neck longitudinally extending from the body to end in a head of the guitar-shaped controller. For the particular embodiment shown in FIG. 2, the fret buttons include a first set of fret buttons 117a linearly arranged on one side of the longitudinal mid-line, and a second set of fret buttons 117b linearly arranged on another side of the longitudinal mid-line. Considering that the guitar-shaped controller may be held by a game player with the neck substantially parallel to the ground, the first set of fret buttons may be considered upper fret buttons, or an upper row of fret buttons, and the second set of fret buttons may be considered lower fret buttons, or a lower row of fret buttons. In some embodiments, and as shown in FIG. 2, each fret button on one side of the longitudinal mid-line is opposed by a corresponding fret button on the other side of the longitudinal mid-line. In addition, in some embodiments, and as shown in FIG. 2, the fret buttons may be positioned about an end of the neck of the guitar-shaped controller. In the particular embodiment of FIG. 2, each of the rows include 3 fret buttons, for a total of 6 fret buttons on the neck of the guitar-shaped controller.

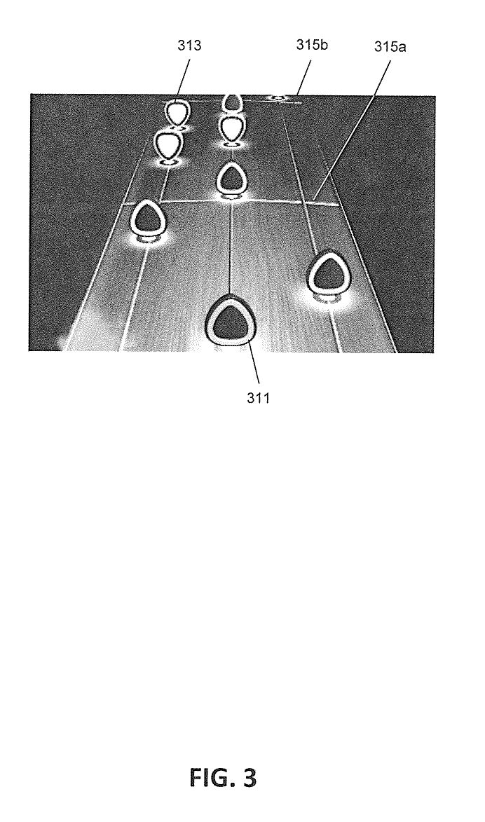

FIG. 3 shows a screenshot of a game display in accordance with aspects of the invention. The screenshot may be displayed, for example, on a display device part of or associated with a video game device, and the display may be as commanded by a processor of the video game device. The screenshot may be displayed during game play provided by the video game system of FIG. 1, for example.

The screenshot shows notes, which provide instructive cues to game players, on what may be called a note highway, in which notes scroll downward in a plurality of defined lanes. In the screenshot of FIG. 3, a first type of note 311 is in a middle lane of three lanes, comprised of a right lane, a middle lane, and a left lane. A second type of note 313 is in the left lane of three lanes. Evenly spaced timing bars 315a, 315b intersect the lanes, with the timing bars being shown as visually similar to frets of a guitar.

The guitar-shaped controller includes two rows of fret buttons, with three fret buttons per row, for a total of six fret button. Other embodiments may use still further rows of fret buttons. The use of three lanes for the display of notes providing instructive cues for a controller with more than three fret buttons may potentially lead to ambiguity as to which fret buttons are to be depressed. Accordingly, in some embodiments, different colors and/or shapes are used to distinguish instructive cues for different rows of fret buttons of a guitar-shaped controller. As used herein, shape includes the form or outline of the instructive cue and its orientation. For example, in some embodiments the first type of note and the second type of note are distinguishable by shape such that they have the same outline but different orientations. In some embodiments the first type of note and the second type of note are distinguishable by shape such that they have different outlines. In some embodiments the first type of note and the second type of note are distinguishable by color. And in some embodiments the first type of note and the second type of note are distinguishable by color and/or one or more aspects of shape.

In the screenshot of FIG. 3, which may be used for gameplay with a guitar having two rows of fret buttons, for example, notes are shown as distinguished by shape (more particularly, orientation) and color. The first type of note 311 has a plectrum shape, with a point of the plectrum pointing upward. The second type of note 313 also has a plectrum shape, with a point of the plectrum facing downward. In various embodiments, the first type of note provides an instructive cue for a game player to depress a fret button of a first row of fret buttons, and the second type of note provides an instructive cue for a game player to depress a fret button of a second row of fret buttons. In some embodiments a plectrum with what may be considered an upward orientation, for example the first type of note 311, may provide an instruction to depress a fret button of what may be considered an upper row of fret buttons. Moreover, if the note is in the middle lane of three lanes, as is the note 311, the note may be considered an instruction to depress a middle fret button of the three fret buttons of the upper row. In addition, the first type of note is also primarily of a first color, while the second type of note is primarily of a second color, and the first and second colors may correspond to colors of fret buttons in a particular row.

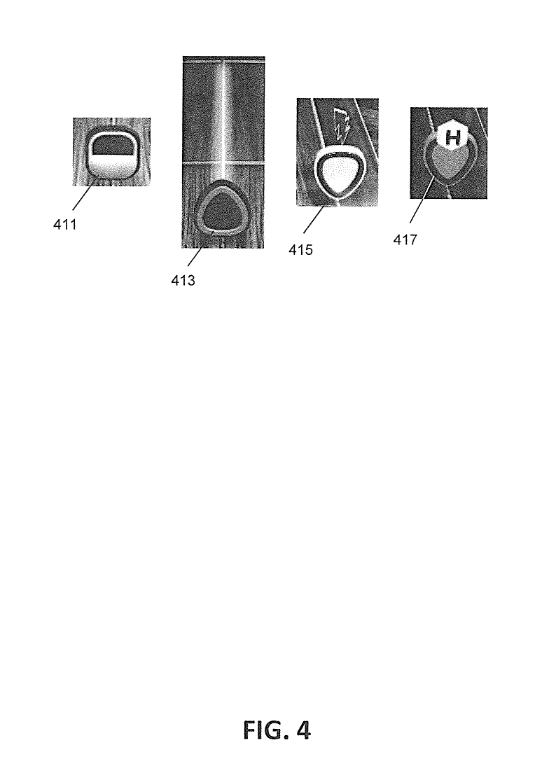

FIG. 4 shows additional forms of notes which may be displayed as instructive cues to game players in various embodiments. A combination note 411 may be displayed to instruct a game player to depress fret buttons from multiple rows. In some embodiments, the combination note has a shape that is symmetrical about a first axis, with notes providing instructions for depression of a fret button of a particular not being symmetrical about the first axis. In some embodiments, and as shown in FIG. 4, the combination note has a shape that is symmetrical about two perpendicular axis, and is generally of square shape. In addition, the combination includes, in generally equal proportions, colors of both of the rows of fret buttons of the guitar-shaped controller of FIG. 2. Accordingly, the combination note, if for example in the middle lane of three lanes, may instruct a game player to depress middle fret buttons of both a first and a second row of fret buttons.

A sustain note 413 may be used to instruct a game player to continue depressing a fret button for a period of time. As shown in FIG. 4, the sustain note includes a visible tail extending upward along the note highway. In most embodiments a length of the tail corresponds to a length of a period of time in which the fret button should be maintained in a depressed state. Other symbols of or associated with notes may also be used to convey to game players other game play information, information that is not providing instructions as to controller operation. For example, an additional icon, for example in the form of a lightning bolt, may be displayed with a note 415 to indicate that a game player has reached a particular game play milestone, for example an unbroken streak of correct compliance with a predefined number of instructive cues. Similarly, if a particular note provides additional benefits, such as a note that may convey special powers, that note may display an additional icon. An example of such an icon is shown as associated with a hero note 417, in which an H icon is shown with the note.

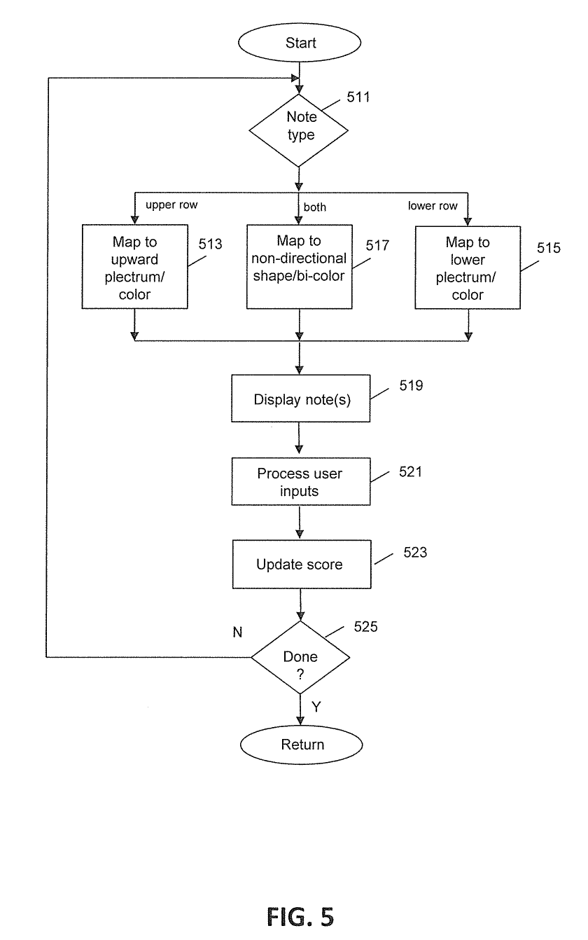

FIG. 5 is a flow diagram of a process of displaying various notes and processing user's inputs during video game play in accordance with aspects of the invention. In most embodiments, the process is performed by a video game compute device. In some embodiments the process is performed, at least in part, by a processor of a video game device. In some embodiments the video game device is a video game console. In some embodiments the process may be performed using video game controller inputs. In some embodiments, the video game controller, for example, is a guitar shaped video game controller that generates an input signal based on the manner in which the video game controller is operated. In some embodiments, the guitar shaped video game controller includes a guitar body with a neck extending from the body. The guitar neck may include a plurality of fret buttons arranged in groups in parallel to one another. In some embodiments each of the parallel groups are arranged linearly along a longitudinal length of the neck, with the buttons for example arranged in upper and lower rows along the guitar neck.

In block 511, the process determines a note type. A note is indicative of an action to be performed by a game player, and, when displayed may be considered an instructive cue. A note generally falls within one of a plurality of note types, which may include, for example, an upper row note, a lower row note, or a combination of both upper and lower row notes. An upper row note type, for example, may correspond to an instruction to depress one or more of a plurality of upper row fret buttons on the neck of the video game controller. A lower row note type, for example, may correspond to an instruction to depress one or more of a plurality of lower row fret buttons on the neck of the video game controller. If the note type is determined to be an upper row note type, the process continues to block 513. If the note type is determined to be a lower row note type, the process continues to block 515. If the note type is determined to be a combination of both upper and lower row note types, the process continues to block 517.

In blocks 513, 515, and 517, the process maps the note type to a particular instructive cue. Properties of the note may include, for example, shape, size, position, orientation, and color.

In block 513, the upper row note type is mapped, for example, to a plectrum shaped instructive cue with an upward orientation. In some embodiments, a color of the upwardly oriented plectrum shaped instructive cue corresponds to a color associated with a fret button to be depressed. In some embodiments each fret button of a particular row has the same color. In some embodiments the upper row of fret buttons is the color black, and the color of the upwardly oriented plectrum shaped instructive cue is black, or primarily black. The process then continues to block 519.

In block 515, the lower row note type is mapped, for example, to a plectrum shaped instructive cue with a downward orientation. In some embodiments, a color of the downwardly oriented plectrum shaped instructive cue corresponds to a color associated with a fret button to be depressed. In some embodiments each fret button of a particular row has the same color. In some embodiments the upper row of fret buttons is the color white, and the color of the downwardly oriented plectrum shaped instructive cue is white, or primarily white. The process then continues to block 519.

In block 517, the combination of both upper and lower row note types is mapped, for example, to a square shaped instructive cue. In some embodiments, a color of the square shaped instructive cue is a combination of black and white, for example such that the upper half of the instructive cue is primarily black and the lower half of the instructive cue is primarily white. However, in various embodiment the instructive cue can be any shape and any combination of one or more plurality of colors. The process then continues to block 519.

In block 519, the process commands display of or displays the notes in the form of instructive cues. In many embodiments, the video game device executes instructions to display the notes on a display device, for example a television or monitor, that is connected to the video game console. The notes may be displayed on a note highway, which may include a plurality of lanes. In some embodiments, each of the notes may be positioned on the left or right lane of the note highway. In some embodiments, each of the notes may also be positioned on a middle lane that is between the left and right lanes of the note highway. Each of the notes appearing on the note highway, for example, represent an instruction for a game player to depress a fret button on the video game controller. When the note reaches the bottom of the note highway, for example, a game player is to actuate a strum bar of the controller while with the fret button depressed.

In block 521, the process processes user inputs. The user inputs stem from the input signals generated by the video game controller as mentioned above. For example, during game play, a game player is to respond to a particular note on the note highway within a particular time. In some embodiments, a catcher represents the time at which the game player is to respond to a note, for example when the note reaches a displayed position of the catcher. In some embodiments, the catcher is a transparent, square shaped element that is generally larger than the note. The game player may, for example, respond to the note by pressing a fret button(s) on the video game controller. Upon pressing the fret button(s), an input signal containing user's input is generated from the video game controller. In some embodiments, the processor of the video game device receives the input signal, processes the user's input from the input signal, and performs a particular operation based on the user's input. In some embodiments, an operation can be providing the game player with feedback about which fret button(s) he/she is currently pressing. Another operation, for example, can be when the game player holds down the fret button(s) from the video game controller, a corresponding note(s) appears at the catcher. In some embodiments, when the game player actuates the strum bar, there is a flash at the catcher.

In some embodiments, the flash at the catcher is white if the strum is at the right time. In some embodiments, the flash at the catcher is red if the strum is not at the right time. The process then continues to block 523.

In block 523, the process updates scores. Extent of user compliance with the instructive cues provided by the notes may be used to provide a score for each user. In some embodiments, game play may continue until a game player is unable to comply with a set of instructive cues. In some embodiments, scores are added when the game player presses the fret button(s) at the right time. In some embodiments, scores are added when the flash at the catcher is white. The process then continues to block 525.

In block 525, the process determines whether to exit the note input mapping and user input processing. In some embodiments the process exits upon completion of game play. If the process determines to remain in the note input mapping and user input processing, the process returns to block 511, and video game play continues. If, instead, the process determines to exit, the process returns.

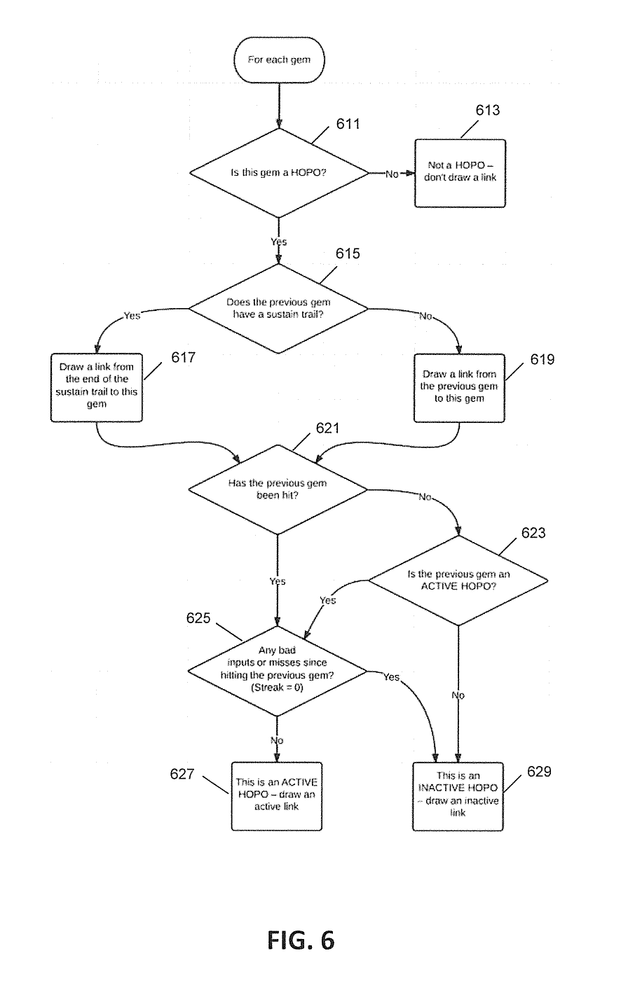

FIG. 6 is a flow diagram of a process of determining where links in a HOPO chain should be drawn. In most embodiments, the process is performed by a video game device. In some embodiments the process is performed by a processor of a video game device, for example in accordance with program instructions stored in memory of the video game device.

In block 611, the process determines if a note is a hammer-on, pull-off (HOPO) note. In some embodiments a HOPO note indicates to a game player that one or more fret buttons are to be depressed, but that activation of a strum bar is not instructed, other than for a first note of a sequence of HOPO notes for which instructive cues are complied with. In some embodiments, the HOPO note is plectrum shaped with an upward or downward orientation. The HOPO note, for example, may be black or white, but it can be any color. In some embodiments, the HOPO note is identified by a bright halo effect around the note, and/or by being visually connected to other HOPO notes, for example by a HOPO chain. The bright halo effect may be white, but it also can be any color. The HOPO chain, for example, may be represented by squiggly lines. However, the HOPO chain does not have to be squiggly, but instead, it can be a straight link between pairs of HOPO notes. If the note is a HOPO note, the process continues to block 615. Otherwise, the process continues to block 613.

In block 613, the process determines that the note is not a HOPO, and thus, does not draw a link between a pair of notes. For example, each note of the pair of notes may be displayed individually on a note highway without a line connecting the pair of notes together.

In block 615, the process determines if a previous note has a sustain trail. A sustain, for example, may be a note for which a game player must continue to hold a relevant fret button on the video game controller for an extended time after strumming, with the sustain trail extending from the note and indicating the extended time during which the fret button is to remain depressed. If the previous note has the sustain trail, the process continues to block 617. Otherwise, the process continues to block 619.

In block 617, the process draws a link from the end of the sustain trail of the previous note to the current note. In some embodiments, the link is a straight line from the end of the sustain trail to the current note. However, in some embodiments, the link is not a straight line.

In block 619, the process draws a link from the previous note to the current note. The link, for example, may be a straight line but again, in some embodiments, the link may not be a straight line.

In block 621, the process determines if the previous note has been hit, namely that the game player has complied with the instructive cue provided by the note. In some embodiments, the previous note has been hit if the game player timely responds to the previous note by pressing a fret button on the video game controller. In some embodiments, the previous note has been hit if the game player actuates the strum bar of a game controller while having appropriate fret buttons in a depressed state. If the previous note has been hit, the process continues to block 625. Otherwise, the process continues to block 623.

In block 623, the process determines if the previous note is an active HOPO note. A HOPO note is active, for example, when the note is in a HOPO chain and the game player has hit all prior HOPO notes in the chain since a last successful strum of a HOPO note in the chain. If the previous note is an active HOPO, the process continues to block 625. Otherwise, the process continues to block 629.

In block 625, the process determines if there is a miss or bad input since hitting the previous note. In some embodiments, the miss or bad input may be a failure to comply with an instructive cue by the game player. If there is a miss or bad input since hitting the previous note, the process continues to block 629. Otherwise, the process continues to block 627.

In block 627, the process determines that the current note is an active HOPO note and draws an active link between the previous and the current notes. The active link, for example, may be a bright effect around a link between a pair of HOPOs. In some embodiments, the link is a squiggly HOPO chain, but in other embodiments, it can be a straight HOPO chain. The bright effect around the link is preferably white, but in some embodiments, it can be any color.

In block 629, the process determines that the current note is an inactive HOPO and draws an inactive link between the previous and the current notes. The inactive link, for example, may be a gray colored line without the bright effect around the link. Again, in some embodiments, the inactive link can be any color. The process thereafter returns.

Although the invention has been discussed with respect to various embodiments, it should be recognized that the invention comprises the novel and non-obvious claims supported by this disclosure.

What is claimed is:

1. A non-transitory computer readable medium including program instructions to program a processor of a video game compute device, the program instructions including program instructions to:
command display of notes on a display, the notes providing instructive cues to a game player, the notes scrolling in a first plurality of lanes, the notes including a first set of notes and a second set of notes, the first set of notes having a first shape and the second set of notes having a second shape different than the first shape, the notes providing instructive cues to a game player for operation of a second plurality of fret buttons of a guitar-shaped controller, a number of the second plurality of fret buttons being at least twice a number of the first plurality of lanes;
determine if user inputs from a game controller indicate game player compliance with the instructive cues provided by the notes; and
increase a score associated with the game player if the user inputs from the game controller indicate game player compliance with instructive cues provided by the notes.

2. The computer readable medium of claim 1, wherein the number of the second plurality of fret buttons is twice the number of the first plurality of lanes.

3. The computer readable medium of claim 1, wherein the first shape and the second shape are not symmetrical about a first axis.

4. The computer readable medium of claim 3, wherein the first shape is a plectrum shape, with a point pointing upward, and wherein the second shape is the plectrum shape, with a point pointing downward, the second plurality of fret buttons are arranged in rows, and notes with the first shape provide instructive cues to the game player to operate fret buttons of a first row of fret buttons and notes with the second shape provide instructive cues to the game player to operate fret buttons of a second row of fret buttons.

5. The computer readable medium of claim 4, wherein the first set of notes is primarily of a first color and the second set of notes is primarily of a second color.

6. The computer readable medium of claim 5, wherein the notes further include a third set of notes, the third set of notes having a third shape different than the first shape and the second shape, the third set of notes providing instructive cues to the game player to operate fret buttons of the first row of fret buttons and fret buttons of the second row of fret buttons.

7. The computer readable medium of claim 1, wherein the program instructions further include program instructions to display connecting lines linking display of notes of a first category.

8. The computer readable medium of claim 7, wherein the user inputs from the game controller include a user input indicative of actuation of a strum bar of the game controller, and at least some of the notes of the first category provide an instructive cue for operation of at least one fret button but do not provide an instructive cue for operation of the strum bar.

9. The computer readable medium of claim 8, wherein notes of the first category may be active or inactive, with display of the connecting lines for active notes being different than display of connecting lines for inactive notes.

10. The computer readable medium of claim 9, wherein the program instructions include program instructions to change active notes of the first category to inactive if the game player fails to comply with an instructive cue while the notes of the first category are active.

11. A video game system for a music-based video game, comprising:
a video game compute device comprising a processor programmed by program instructions to provide for video game play of the music-based video game; and
a guitar-shaped controller having a body with a neck extending longitudinally from the body, a strum bar providing a strum bar input protruding from a face of the body, and a plurality of fret buttons on the neck, the plurality of fret buttons including a first set of fret buttons and a second set of fret buttons, each fret button of the first set of fret buttons opposing a corresponding fret button of the second set of fret buttons across a plane including a line defined by a longitudinal middle of the neck;
with the program instructions including program instructions to:
command display on a display of notes moving in a plurality of lanes, the notes providing instructive cues to a game player as to operation of the plurality of fret buttons, the notes including a first set of notes having a first shape and a second set of notes having a second shape, the first set of notes providing instructive cues to the game player to operate the first set of fret buttons, the second set of notes providing instructive cues to the game player to operate the second set of fret buttons, with notes of the first set and notes of the second set each moving in each of the plurality of lanes, each lane of the plurality of lanes being associated with a different fret button of the first set of fret buttons and a different fret button of the second set of fret buttons,
determine game player compliance with the instructive cues based on inputs from the fret buttons of the guitar-shaped controller and the strum bar input, and
increase a score associated with the game player if the game player has complied with the instructive cues.

12. The video game system of claim 11, wherein the first set of fret buttons and the second set of fret buttons each include a same number of fret buttons.

13. The video game system of claim 12, wherein the number of fret buttons in the first set of fret buttons and a number of lanes in the plurality of lanes is the same number.

14. The video game system of claim 13, wherein the first set of fret buttons consists of three fret buttons, the second set of fret buttons consists of three fret buttons, and the plurality of lanes consists of three lanes.

15. The video game system of claim 11, wherein the first set of fret buttons are arranged in a first row, the second set of fret buttons are arranged in a second row, and the first shape provides a first visual indicator pointing in a first direction, and the second shape provides a second visual indicator pointing in a second direction.
